(19) United States
(12) Patent Application Publication
(10) Pub. No.: US 2026/0285000 A1
(43) Pub. Date: Sep. 24, 2026

(54) METHOD FOR MANUFACTURING A CONTAINER AND MANUFACTURING DEVICE

(71) Applicant: MONDI AG, Wien (AT)

(72) Inventors: Damian SOBCZAK, Wierzbica (PL); Piotr STASIECKI, Wierzbica (PL); Jacek LEPEK, Starachowice (PL)

(21) Appl. No.: 19/474,338

(22) PCT Filed: Apr. 14, 2023
(86) PCT No.: PCT/EP2023/059820

§ 371 Date: Oct. 10, 2025

(51) Int. Cl. B31B 70/81; B31B 70/04; B31B 70/16; B31B 70/26; B31B 70/62

(52) U.S. Cl. CPC B31B 70/81; B31B 70/04; B31B 70/16; B31B 70/26; B31B 70/62

(57) ABSTRACT

This invention relates to a method for manufacturing a container made of paper, in particular a paper bag, in a manufacturing device, the method comprising the following steps: Providing paper on a roll, forming a paper tube in a tube unit of the manufacturing device, the paper tube having an open first end and an open second end and a longitudinal direction extending from the first end to the second end, folding a bottom in a bottom unit of the manufacturing device to form a closed paper tube, providing a closure flap, adhering the closure flap in an adhesive unit of the manufacturing device such that the closure flap protrudes longitudinally beyond the second end.

The invention relates to a method of manufacturing a container made of paper, in particular a paper bag, in a manufacturing device, the method comprising the following steps: providing paper on a roll, forming a paper tube in a tube unit of the manufacturing device, the paper tube having an open first end and an open second end and a longitudinal direction extending from the first end to the second end, and folding a bottom in a bottom unit of the manufacturing device so as to form a closed paper tube.

Containers made of paper, particularly paper bags, are used in various applications and in large numbers and have long been known in the prior art. In recent years, there has been a strong increase in online retailing, where a customer orders one or more items online, preferably to be delivered to their home. This requires packaging that must meet different criteria. The packaging must be cost-effective and producible in large quantities. It must also be as well adapted as possible to the size and shape of the item to be shipped, or at least be adaptable. Preferably, the packaging is also sustainable, i.e. preferably made from renewable raw materials and recyclable.

The use of boxes or cartons, which have long been used as shipping containers, has the disadvantage that either a large number of different sizes and dimensions must be kept on hand or it must be accepted that the box or carton used in each case has dimensions that are larger than necessary for the item to be shipped. This leads to void space inside the boxes or cartons, making the shipment ineffient, due to the amount of air, that is shipped inside the boxes or cartons. In addition, in order to prevent the object to be shipped from moving inside the box or carton, the void space has to be filled with some kind of filling material, such as plastic bubble wrap, void paper or padding chips. This increases the cost and the amount of packaging waste. Therefore, the use of bags or sacks is increasing strongly, whereby in particular the use of paper bag or other containers made of paper has the advantage over similar packaging made of a plastic that the containers can be recycled.

Thus, it is known from the prior art to use paper bags having a folded bottom and an open end, hereinafter referred to as the second end. The folded bottom ist he first end of the paper bag. At the second end there is a closure flap to which at least one retaining element, for example an adhesive strip or an adhesive strip, is arranged. After the article to be shipped has been inserted into the paper bag, the closure flap can be folded down and held in this position by the retaining element so that the open end is covered and thus closed. For this to work, it is important that the closure flap protrudes longitudinally beyond the edge of the second end.

To achieve this, two different procedures are known in principle in the prior art. In the first approach, the closure flap is formed integrally with the remainder of the base body. The base body preferably is formed from a closed paper tube, which is a paper tube having a folded bottom at the end opposite the open end. Preferably, the folded bottom is also formed integrally with the rest of the base body. The closure flap, which is formed integrally with the remainder of the base body, is produced in this case by cutting the paper web, which forms the tubular base body, accordingly. The open end, which can also be referred to as the filling opening, has an edge. This edge is at a distance from the folded bottom of the base body, this distance being greater in the area forming the closure flap than in the remaining area. In this way, a closure flap is achieved which protrudes longitudinally beyond the open end. A disadvantage is that this results in waste material that has to be disposed of as waste. In addition, cutting the base body to size is complicated and requires complex manufacturing equipment.

In the second approach, this cutting of the base body is unnecessary. The closure flap is manufactured as a separate component and, after the base body has been manufactured, is adhered to the basic body in such a way that it projects beyond the open end of the basic body. A disadvantage is that a second manufacturing device is required for this purpose, and the base body manufactured in the first manufacturing device must be transported to this second manufacturing device. In addition, the second manufacturing device is not fully automatic, but will need at least one operator to feed the bags manually and at least one operator to pick up the bags after the flap has been attaches. This increases the production costs and also slows down the production speed.

The invention is therefore based on the task of proposing a method of manufacturing a container made from paper and a manufacturing device to be used for this method, with which the disadvantages of the prior art are avoided or at least mitigated. The invention solves this problem by a method of the type described above, which is characterized in that a closure flap is provided which is adhered in an adhesive unit of the manufacturing device in such a way that the closure flap protrudes in the longitudinal direction beyond the second end. Thus, instead of requiring a second manufacturing device and additional operators performing manual operations for this part of the manufacturing process, it is provided according to the invention that the entire process is carried out in a single manufacturing device.

First, paper from which the paper container is to be made is provided on a roll. Such a roll is also referred to as an endless roll, although the wound paper is of course not actually endless. A paper tube is first made from the paper thus provided. This is done as known in the prior art in a tube unit of the manufacturing device. The paper is transported through the manufacturing device in a feed direction. The two side edges of the paper provided, which are parallel to the feed direction, are folded over to produce the paper tube and joined together in the middle. In this way, a paper tube is formed which, like the paper provided, is endless. This endless paper tube can then be separated, for example cut, into individual paper tubes. Alternatively, the provided paper can first be cut to the desired length before the resulting sheets are folded into the paper tubes. Regardless of the chosen procedure, the paper tube has an open first end and an open second end and a longitudinal direction extending from the first end to the second end. Preferably, the longitudinal direction extends parallel to the feed direction.

Subsequently, the first end of the paper tube is closed by folding a bottom, for example a cross bottom. The cross bottom can be glued with an additional reinforcing sheet and thus be reinforced. A paper tube closed with a bottom at the first end is called a closed paper tube. The closing of the first end is done in the bottom unit of the manufacturing device.

In an adhesive unit of the manufacturing device, the provided closure flap is adhered to the closed paper tube. The closed paper tube is the base body of the container to be manufactured. The closure flap is preferably arranged on the outside of the base body. It is arranged so that it protrudes longitudinally beyond the second end. This means that the closure flap can be folded over in such a way that it can cover the open second end and thus the filler opening. The closure flap preferably has at least one retaining element, for example an adhesive strip or adhesive tape. This is arranged to interact with the outer side of the base body, i.e. the closed paper tube, when the filling opening is to be closed by the closure flap. Alternatively or additionally, the retaining element, for example the adhesive strip or adhesive tape, can also be arranged on the outside of the closed paper tube, so that it comes into contact with a folded-down closure flap and thus retains the closure flap in its position closing the filling opening. In a preferred embodiment, the retaining element, for example the adhesive strip or adhesive tape, is covered by a covering element, for example a paper strip. The retaining element can thus be activated by removing the cover element.

Preferably, the paper tube is moved along an feeding direction through the tube unit of the manufacturing device, wherein the longitudinal direction extends parallel to the feeding direction. This means that the paper tube leaves the tube unit in feeding direction in this orientation. In a preferred embodiment the papaer tube is then rotated in a rotating unit before the bottom is mannufactured in the bottom unit. The rotating unit may be a separate unit of the manufacturing device or may be formed as part of the bottom unit or as part of the tube unit.

In a preferred embodiment the tubes are stacked after leaving the tube unit and are then rotated in the rotating unit of the manufacturing device. They are then fed into the bottom unit in the new rotated orientation. Different embodiments of rotating units are known from prior art that can be used. The rotating unit can comprise different conveyor belts that preferably run in different directions and/or at different speed. The rotating unit can additionally or as an alternative comprise at least one of a pusher, a bag elevator, a turn table, a tube feeder and a tube transfer device.

In a particularly preferred embodiment, the closed paper tube is rotated through 90° in the rotating unit. This results in the longitudinal direction of the closed paper tube extending perpendicular to the feeding direction after this rotation. The closure flap is preferably adhered to the closed paper tube along a strip which, as a result of the rotation of the closed paper tube, extends preferably parallel to the feeding direction. In this way, it is particularly easy to adhere the provided closure flap.

Preferably, the manufacturing device has a flap unit in which the closure flap is manufactured before it is provided.

In a preferred embodiment, the closure flap has at least two retaining elements and at least one tear-open element arranged between these retaining elements. If the container is made of paper, the article to be packaged is first inserted into the container through the filling opening, i.e. the open second end. Subsequently, the closure flap is folded down and, in the preferred embodiment, is held by the first of the two retaining elements in this folded-down position in which the filling opening is at least partially, but preferably completely, covered. For this purpose, it may be necessary to activate the first of the two retaining elements, for example by removing a cover element. In this case, the first of the two retaining elements is the retaining element which is furthest away from the area of the closure flap with which it is arranged on the base body of the container, i.e. the closed paper tube. By means of the tear-open element, it is possible to divide, preferably tear, the closure flap into two parts. If this happens when the closure flap is held in the folded-down position by the first retaining element, the one part of the closure flap on which the first retaining element is located remains on the base body, since it is held to the latter by the first retaining element, preferably is adhered to the latter. The remaining part of the closure flap can be folded back again from the folded-down position, so that the filling opening is accessible again. This is advantageous for removing the packaged item from the container. Such flaps and the corresponding containers are known from the prior art such as DE 10 2015 001 206 A1, in which differen ways to position and/or orient the retaining elements and the tear-open element are shown. Also shown are different kinds of retaining elements and tear-open elements.

In online retailing in particular, items shipped to the customer are often returned to the retailer, for example because an item of clothing ordered does not fit. For this purpose, the customer requires a corresponding shipping bag, i.e. a container preferably made of paper. In the embodiment described here, in which the closure flap has two retaining elements, the container can be reused. The article is reinserted into the container, which is possible through the open filling opening. Subsequently, the remaining part of the closure flap is again folded and now positioned again on the base body, i.e. the closed paper tube, by means of the second of the two retaining elements.

Preferably, the at least two retaining elements and the at least one tear-open element are applied to a continuous paper web, the continuous paper web then being divided in such a way that individual closure flaps are formed.

The invention further solves the given problem by a manufacturing device for carrying out a method according to any one of the preceding claims, characterized in that the manufacturing device comprises a tube unit, a bottom unit and an adhesive unit.

Preferably, the manufacturing device also has a rotating unit. A rotating unit is understood to mean any unit by which the orientation of the closed paper tubes to be moved can be changed, in particular rotated, relative to the feeding direction. It is not necessary for the feeding direction to remain constant. While this is a preferred embodiment, it is also possible not to change the orientation of the closed paper tubes in space and instead to rotate the feeding direction. This can be achieved, for example, by first moving the closed paper tubes along a first direction by a first conveying device so that the first direction is the feeding direction, preferably with the longitudinal direction of the closed paper tubes being parallel to the feeding direction and thus parallel to the first direction. The rotating device then has a second conveying means on which the closed paper tubes are placed and which then moves the closed paper tubes in a second direction which is different from the first direction. For example, if the second direction extends perpendicular to the first direction, the orientation of the closed paper tubes has rotated 90° relative to the feeding direction, which is now formed by the second direction.

Preferably, the adhesive unit, especially preferably in combination with the rotating unit, is detachably arranged on the rest of the manufacturing device. With this embodiment, it is also possible to convert existing manufacturing device, with which, for example, closed paper tubes can be manufactured, in such a way that they can utilize the advantages of the present invention.

In a preferred embodiment, the adhesive unit has at least one speed sensor for determining a feeding speed of the closed paper tube and/or at least one position sensor for determining a position of the closed paper tube. Such a position sensor can be, for example, a photo eye by means of which it is possible to detect when the paper tube reaches a certain position, which is reached, for example, when the photo eye is interrupted by the closed paper tube.

Preferably, the production device is set up to produce at least 100 containers per minute, preferably at least 150 containers per minute, more preferably at least 175 containers per minute.

In the following, an example of an embodiment of the present invention will be explained in more detail by way of drawings. They show:

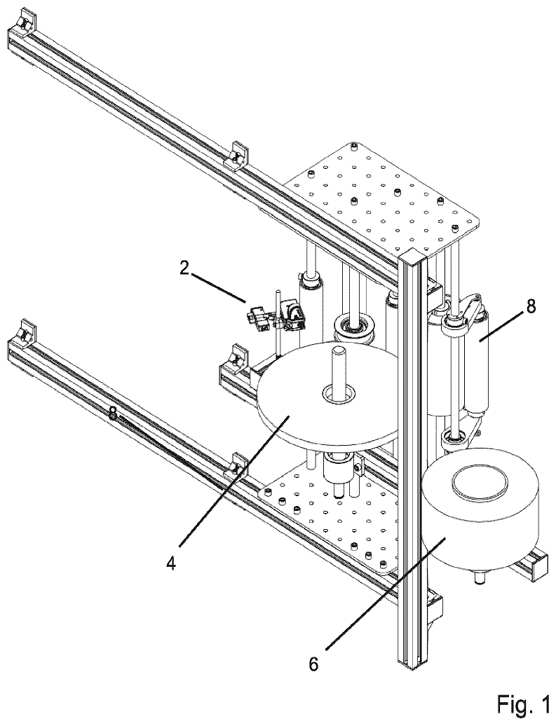

FIG. 1—a flap unit in a 3-dimensional view

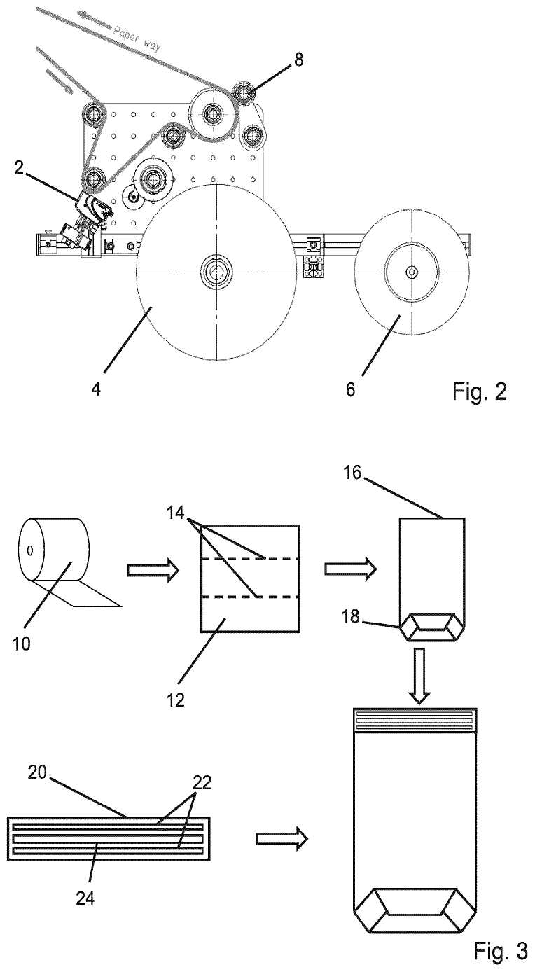

FIG. 2—the flap unit of FIG. 1 in a top view

FIG. 3—a schematic representation of a method according to one embodiment of the present invention.

FIG. 1 shows a flap unit of a manufacturing device accoring to the present invention in a 3-dimensional view. FIG. 2 shows the same flap unit in a top view. The flap unit comprises an applicator 2 for an adhesive, a silicone tape unwinder 4 and a tear-open tape unwinder 6. Paper is fed into the flap unit along the paper way depicted in FIG. 2. First the paper is lead to the applicator 2. Here, the adhesive is applied to the paper, which is needed to adhere the closure flap, that is produced in the flap unit, to the closed paper tube. The closed paper tube is made by closing one end of a paper tube by folding an bottom to one oft he open ends. The second end of the closed paper tube is open. A silicone tape is provided on the silicon tape unwinder 4 and a tear-open tape is provided on the tear-open unwinder 6. Both tapes are applied to the paper at the pulley 8. Both tapes are unwound from the supply roll, that is provided on the respective unwinder 4,6 by the moving paper.

FIG. 3 shows various intermediate steps that occur in a process according to an embodiment of the present invention. First, the paper is provided in the form of a roll 10. In the embodiment shown, individual sheets 12 are cut from it, which are then processed into a tube by folding along the folding lines 14 shown in dashed lines. The first end 16 remains open. The opposite second end 18 is closed by folding on a bottom. In a separate step, the flap 20 of is produced in the flap unit. In the embodiment shown, this flap 20 has two retaining elements 22 and a tear-open element 24 located between them. This flap 20 is then adhered to the open end 16 of the closed paper tube so that a paper shipping bag is created.

### LIST OF REFERENCE NUMBERS

2 applicator
4 silicon tape unwinder
6 tear-open unwinder
8 pulley
10 roll
12 sheet
14 folding line
16 first end
18 second end
20 flap
22 retaining element
24 tear-open element

1. A method for manufacturing a container made of paper, comprising
providing paper on a roll,
forming from the paper on the roll a paper tube in a tube unit of a manufacturing device, wherein the paper tube comprises an open first end and an open second end and a longitudinal section extending in a longitudinal direction from the first end to the second end,
folding a bottom at the first end of the paper tube, wherein folding is performed in a bottom unit of the manufacturing device to form a closed paper tube,
providing a closure flap, and
adhering the closure flap in an adhesive unit of the manufacturing device such that the closure flap protrudes longitudinally beyond the second end of the closed paper tube.

2. The method according to claim 1, wherein the paper tube is rotated in a rotating unit of the manufacturing device before the bottom is folded to form the closed paper tube.

3. The method according to claim 2, wherein the paper tube is rotated by 90° in the rotating unit.

4. The method according to claim 1 further comprising producing the closure flap in a flap unit of the manufacturing device.

5. The method according to claim 4, wherein the closure flap has at least two retaining elements and at least one tear-open element arranged between the at least two retaining elements.

6. The method according to claim 5, wherein the at least two retaining elements and the at least one tear-open element are applied to a continuous paper web, wherein the continuous paper web is subsequently divided such that individual closure flaps are formed from the continuous paper web, the at least two retaining elements, and the at least one tear-open element.

7. A manufacturing device for performing a method according to claim 1, comprising a tube unit, a bottom unit, and an adhesive unit.

8. The manufacturing device according to claim 7, further comprising a rotating unit.

9. The manufacturing device according to claim 7 wherein the adhesive unit is detachably arranged on the manufacturing device.

10. The manufacturing device according to claim 7 wherein the adhesive unit comprises at least one speed sensor for determining a feed speed of the closed paper tube and/or at least one position sensor for determining a position of the closed paper tube.

11. The manufacturing device according to claim 7 wherein the manufacturing device is configured to produce at least 100 containers per minute.
